(19) United States
(12) Patent Application Publication
(10) Pub. No.: US 2008/0177665 A1
(43) Pub. Date: Jul. 24, 2008

(54) System and method for secure asset management

(76) Inventor: Pieter Noordam, San Jose, CA (US)

Correspondence Address: Pieter Noordam, 1438 Calle Alegre, San Jose, CA, 95120, US

(21) Appl. No.: 11/975,597

(22) Filed: Oct. 19, 2007

Related U.S. Application Data
(60) Provisional application No. 60/854,485, filed on Oct. 25, 2006.

(51) Int. Cl. H04L 9/32; G06Q 10/00

(52) U.S. Cl. 705/50

(57) ABSTRACT

A system and method of secure asset management comprising an RFID tag attached to an asset, a portable computing device equipped with an RFID transceiver, an inspector RFID authentication badge, and a central database server. The RFID tag includes historical management records of the asset and a cryptographic hash calculated over relevant information to ensure security and authenticity thereof. The portable computing device can read from and write to the RFID tag and read from the RFID authentication badge. Management tasks to be performed by the inspector are determined by the portable computing device based on the authorization level of the inspector read from the RFID authentication badge and the asset information read from the RFID tag. Upon completion of asset management, historical management records are generated by the portable computing device and securely written to the RFID tag by including a cryptographic hash calculated over the relevant information. Historical management records may also include an identifier of the inspector, a timestamp of when the historical management record was generated, and error correction or detection data. Such historical management records may be synchronized with a central database server at a later time.

This application claims the benefit of U.S. Provisional Patent Application No. 60/854,485, filed Oct. 25, 2006, by applicant Pieter Noordam.

### BACKGROUND OF THE INVENTION

The present invention relates generally to asset maintenance, inspection, tracking, assembly, diagnosis, or repair, heretofore referred to as management. Assets, such as cars, refinery equipment, fire extinguishers, patients in a hospital, manufactured goods on an assembly line, and forklifts, are heretofore referred to generally as assets. Asset management may be important in many settings, such as manufacturing, production, warehouse, office, business, and construction. Management may be of utmost importance for safety.

Organizations, including governments and regulating agencies like the Occupational Safety and Health Administration (OSHA) and the Food and Drug Administration (FDA), companies, and clubs or groups of people, have determined certain processes and procedures for asset management that conform to minimum safety standards. These processes and procedures describe actions, tasks, and inspections, and frequency thereof, to be performed on assets by an owner, user, or inspector.

Management compliance can be verified by inspecting management records. The records must uniquely identify the asset, for example by serial numbers, bar codes, or Radio Frequency Identifiers (RFIDs). Such records must show that the required management processes and procedures were in fact performed and the results of such processes and procedures. Finally, it may be extremely important that the records be authentic, or not falsified or falsifiable.

Records can also include important information like historical data on the asset, such as results of past inspections, age, location of use, or amount of use. Such historical data may be crucial to the management processes and procedures of an asset. It may therefore be necessary to retrieve historical data records of an asset prior to, or during, a management inspection. Currently, there are two types of management records keeping: (1) paper records (hard copy), and (2) database records (soft copy). Paper records are typically completed inspections checklists. Database records can be constructed via later data entry of paper inspections checklists or via data entry into a portable or mobile computing device that communicates, typically using a wireless network, with the database during or after asset management.

Database records can be (1) retrieved and viewed from a desktop computer prior to asset inspection, or (2) retrieved from a portable of mobile computing device at the asset. For both methods, access to the database is required. However, the location of an asset, type of asset, unavailability of a wireless network, unavailability of a desktop computer or printer, or impracticality of paper records, may make it impossible to access historical data records. Furthermore, paper copies of historical data records kept with the asset can be easily lost, damaged, or falsified.

The prior art teaches a number of methods and systems for asset tracking and compliance.

U.S. Pat. No. 6,571,158 (Sinex) and U.S. Pat. No. 6,580,982 (Sinex) disclose systems for dynamic maintenance management; however, the systems do not reliably identify an asset by electronic means and do not provide a means to record asset related data at the asset.

U.S. Pat. No. 6,804,626 (Manegold, et. al.) discloses a system and process to ensure compliance to mandatory safety and maintenance of an asset and to record the relevant inspection data; however, the system does not provide a means to authenticate an inspector nor provide a means to protect the relevant inspection data from falsification. Furthermore, the system does not provide a means to store the inspection data at the asset.

U.S. Pat. No. 6,839,604 (Godfrey, et. al.) discloses a compliance tracking method for a manufacturing environment; however, the system does not provide a means to authenticate an inspector. Furthermore, the system employs stationary RFID transceivers rather than portable RFID transceivers. The system does not provide a means of guiding an inspector during the inspection. Finally, the system does not provide a means to protect inspection data from falsification.

U.S. Pat. No. 7,117,212 (Brinton, et. al.) discloses a system to ensure compliance of mandatory asset inspection; however, the system does not provide a means to authenticate an inspector nor provide a means to protect the relevant inspection data from falsification. Furthermore, the system does not provide a means to store the inspection data at the asset.

U.S. Pat. No. 7,161,489 (Sullivan, et. al.) discloses a system to track movement of articles through a supply chain; however, the system employs stationary RFID transceivers rather than portable RFID transceivers. The system does not provide a means to authenticate an inspector nor provide a means to protect inspection data from falsification.

U.S. Pat. No. 7,171,381 (Ehrman, et. al.) discloses a system for asset management which does provide for a means to store the inspection data at the asset; however, the storage means is a battery powered device connected to a wireless network. Additionally, the system does not provide a means to authenticate an inspector nor provide a means to protect inspection data from falsification. Finally, the system does not provide a means of guiding an inspector during the inspection.

U.S. Pat. No. 7,178,416 (Whelan, et. al.) discloses an automated clinical test system; however, the system employs stationary RFID transceivers rather than portable RFID transceivers. The system does not provide a means to authenticate an inspector nor provide a means to protect inspection data from falsification. Additionally, the system does not provide a means of guiding an inspector during the inspection. Finally, the system does not provide a means to store the inspection data at the asset.

U.S. Pat. No. 7,195,149 (Baker, et. al.) discloses a hose tracking system employing RFID tags; however, the system does not provide a means to store asset data on the RFID tag or use the RFID tag identification to retrieve the information from a network. The system does not provide a means of guiding an inspector during the inspection. Finally, the system does not provide a means to store the inspection data at the asset.

U.S. Pat. No. 7,210,625 (McNutt, et. al.) discloses a system for managing assets; however, the system does not provide a means to authenticate an inspector nor provide a means to protect asset data from falsification.

U.S. patent application Ser. No. 10/204,838 (Godfrey, et. al.) discloses a system for tracking and compliance of manufactured goods in a production environment; however, the system does not provide a means to authenticate an inspector nor provide a means to protect asset data from falsification. Additionally, system does not provide a means of guiding an inspector during the inspection.

None of the systems taught in the prior art, taken individually or in aggregate, provide for a system or method for asset tracking or compliance (management) that provides a means for (1) storing asset and inspection related data at the asset, (2) protecting such data from falsification, (3) authenticating an inspector prior to asset inspection, and (4) guiding an inspector through asset inspection. Accordingly, what is desired, and has not heretofore been developed, is a system and method of asset management that provides a means for storing asset and inspection related data at the asset, protecting such data from falsification, authenticating an inspector prior to asset inspection, and guiding an inspector through an asset inspection.

### BRIEF SUMMARY OF THE INVENTION

It is an object of the present invention to provide a system and method of asset management.

It is an object of the present invention to attach RFID tags to an asset and provide a means to read from and write to an internal memory of such RFID tags.

It is an object of the present invention to provide a means to protect the asset and inspection related data stored on an RFID tag from falsification.

It is an object of the present invention to provide a means to authenticate an inspector prior to asset inspection.

It is an object of the present invention to provide a means of guiding an inspector during an asset inspection.

It is an object of the present invention to provide a means to selectively guide an inspector during an asset inspection based on the asset-related data read from the RFID tag of an asset and the authorization level of the authenticated inspector.

It is an object of the present invention to provide a means to synchronize asset and inspection-related data stored on an RFID tag with a central database.

### BRIEF DESCRIPTION OF THE DRAWINGS

FIG. 1 shows an inspector accessing the internal memory of an RFID tag attached to an asset.

FIG. 2 shows the elements of the system implementing asset management, including accessing historical data records from an RFID tag, comprising a database server, portable computer, RFID transceiver, and RFID badge, and RFID tag.

FIG. 3 shows the internal data structure of an RFID tag used as the authentication badge for an inspector.

FIG. 4 shows the internal data structure of an RFID tag to store information pertaining to the asset.

FIG. 5 shows the internal data structure of an RFID tag to store the results of performed inspection observations, tasks, and readings.

FIG. 6 shows the general structure of an RFID tag to store data.

FIG. 7 shows the directory structure indicated in FIG. 2 and FIG. 3.

FIG. 7 shows the steps for inspector authentication.

FIG. 8 shows the steps for asset management, including authenticating an inspector, reading the information on an asset's RFID tag, guiding the inspection, entering the inspection results, auditing the inspection results, and writing the inspection results to the asset's RFID tag.

### DETAILED DESCRIPTION OF THE INVENTION

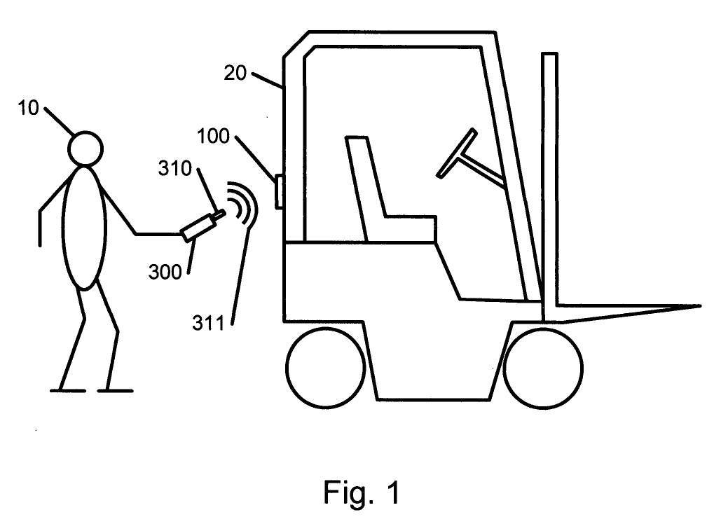

FIG. 1 shows an inspector, technician, asset owner, asset user, or other person with the desire, capability, or authorization to inspect an asset, heretofore called an inspector 10, in close proximity to an asset 20 that is to be inspected. The inspector 10 operates a portable computer 300, for example a Portable Digital Assistant (PDA), which includes an RFID transceiver 310 for communicating with an RFID tag 100 attached to the asset 20. The inspector 10 places the RFID transceiver 310 within close proximity to RFID tag 100 such that RFID transceiver 310 may communicate with the RFID tag 100 via a wireless communications protocol 311, for example ISO15963 or ISO 14443A/B. Close proximity to the RFID tag 100, approximately 1-10 cm, helps ensure (1) the inspector of the asset is truly at the asset to be inspected, and (2) communication with the RFID tag 100 is not interfered with by another nearby RFID tag. Such action is performed during step 810 of FIG. 9.

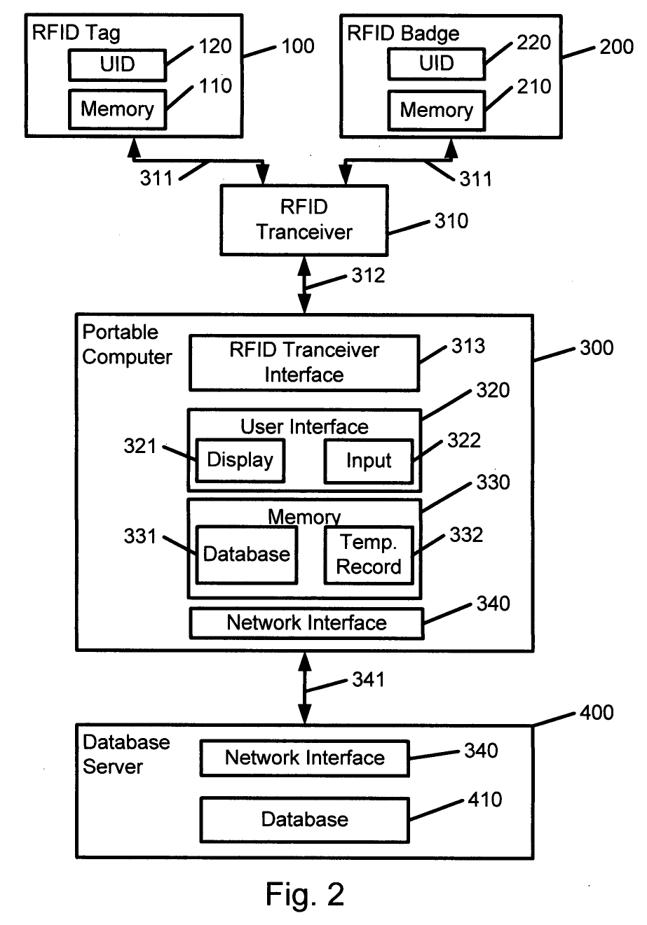

FIG. 2 shows the block diagram a system implementing a method of asset management by accessing and storing information pertaining to an asset 20. Information pertaining to the asset 20 may include asset identification, management information, and historical data records. The RFID tag 100 that is attached to an asset 20 has a unique identifier, heretofore referred to as the RFID tag UID 120, and an internal memory 110 that can be accessed by an RFID transceiver 310 via a wireless communications protocol 311. The inspector 10 has an RFID badge 200 that has its own unique identifier, heretofore referred to as the RFID badge UID 220, and an internal memory 210 that can also be accessed by an RFID transceiver 310 using a wireless protocol 311. A portable computer 300 includes an RFID transceiver interface 313 that communicates with the RFID transceiver 310 via an RFID transceiver interface 312, such as SDIO or Bluetooth. Alternatively, the RFID transceiver 310 could be integrated within the portable computer 300.

The portable computer 300 includes a network interface 340 for communicating with a network interface 340 of a database server 400 via a network 341. Such network 341 may be either wireless or wired. The database server 400 includes a central database 410 that stores global asset management records. The portable computer 300 includes a portable computer memory 330 which may include a temporary record 332 and a local database 331 that can synchronize with a central database 400 using any database replication and synchronization mechanism.

The inspector 10 interfaces with the portable computer 300 via a user interface 320. A display element 321 may provide guidance or instructions to the inspector 10. Alternatively, the guidance or instructions may be provided by the user interface 320 audibly by a speaker element. Heretofore the term display element 321 refers to either a visual display element or an audible speaker element. The inspector 10 may follow the guidance or instructions, and may provide results of such guidance or instructions to the portable computer 300 via a user input device 322. The user input device 322 may be via physical buttons or keys on the portable computer 300, soft buttons or keys displayed on the display element 321, or a microphone cooperating with voice recognition and translation software running on the portable computer 300.

Prior to beginning an inspection, the inspector 10 must authenticate. Authentication is the act of securely verifying the identity of the inspector 10. Authentication is important because it helps ensure the appropriate inspector 10 is in fact the person conducting the inspection, which is especially crucial for assets of extreme importance, such as life support assets, which require the inspector 10 be qualified or authorized to inspect such an asset. An inspector 10 may be assigned an authorization level, for example an integer from 1 to 10 where 1 is the lowest authorization level and a 10 is the highest authorization level. The tasks to be performed for an asset 20 during inspection may also be assigned an authorization level, for example an integer from 1 to 10 where 1 is the lowest authorization level and 10 is the highest authorization level. The portable computer 300 would only prompt an inspector to perform a task when the authorization level of the inspector, which is read from the RFID badge memory 210 via the RFID transceiver 310, is at least as high as the authorization level of the task.

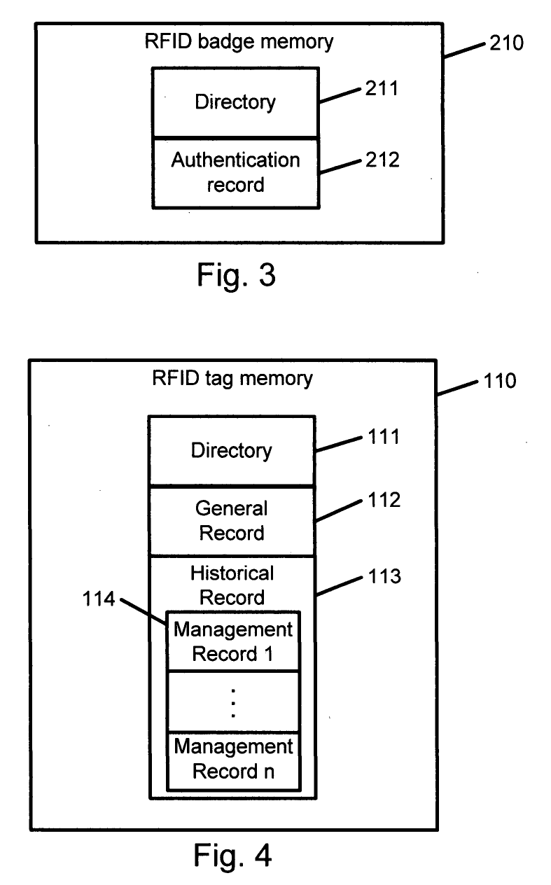

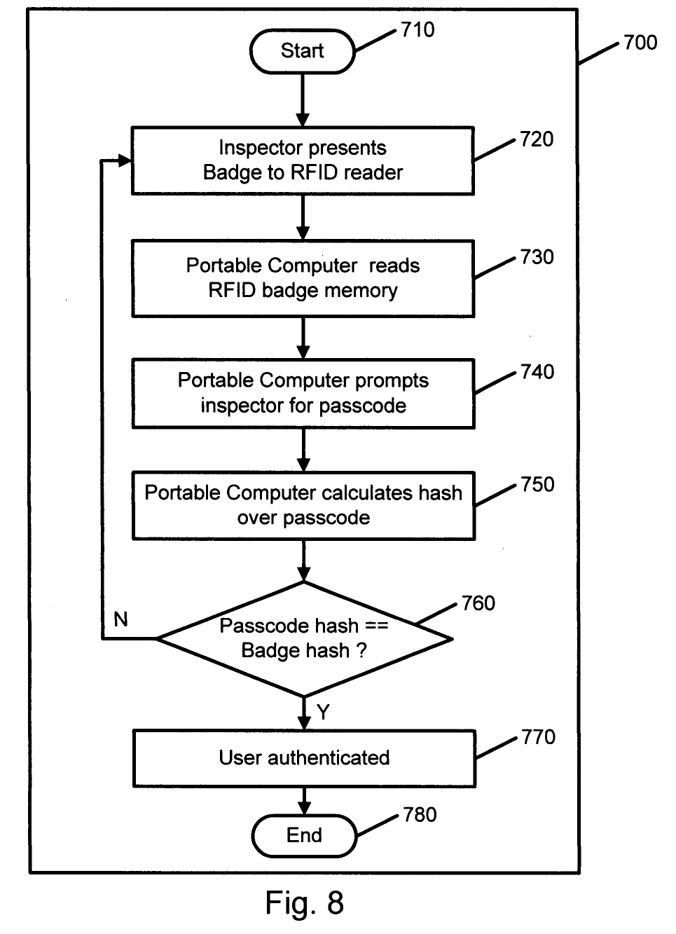

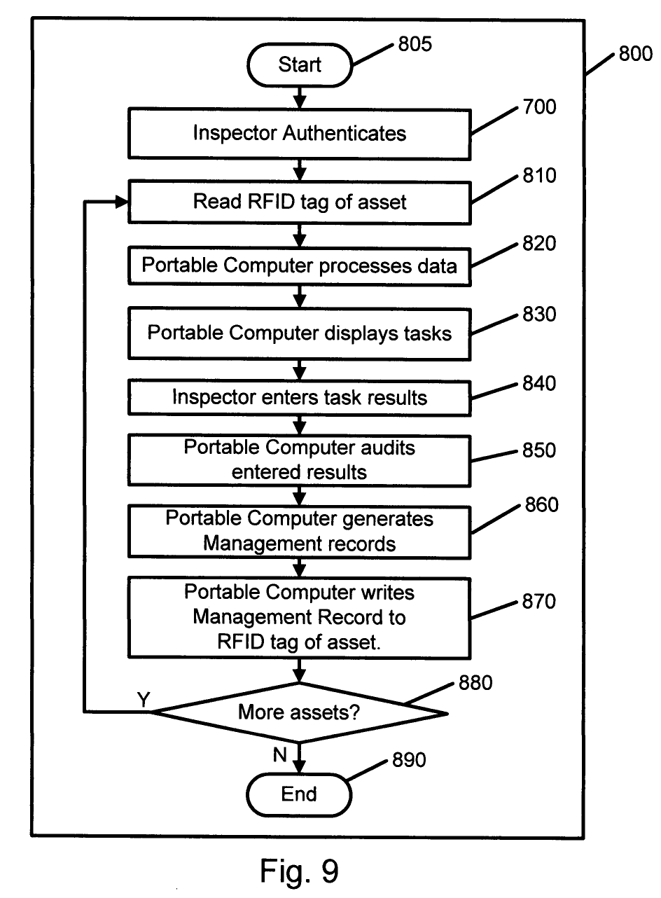

FIG. 8 shows a process of inspector authentication 700, beginning with the start step 710 and ending with the end step 780. To authenticate, the inspector 10 brings his or her RFID badge 200 in close proximity to the RFID transceiver 310, as in step 720 of FIG. 8. The RFID badge 200, shown in FIG. 3, includes an RFID memory 210 which may include a directory 211 that indexes the data stored in the authentication record 212. The authentication record 212 may include a company identifier, inspector identifier, inspector authorization level, inspector authorization level expiration date, badge issuance date, and encrypted passcode such as a Personal Identification Number (PIN) code. In step 730 of FIG. 9, the portable computer 300 reads the RFID badge 200 via the RFID transceiver 310 to access the authentication record 212. Next, in step 740, the portable computer 300 prompts the inspector 10 to enter his or her passcode via the user interface 320. In step 750, the portable computer 300 calculates a hash over the entered passcode and compares it to the hashed passcode retrieved from the RFID badge memory 210. The hashed entered passcode is compared to the hashed retrieved passcode in step 760: if the two hashed passcodes match, the inspector is authenticated as shown in step 770; if the two hashed passcodes do not match, the inspector may return to step 720 to attempt to reauthenticate.

Once the inspector 10 authenticates, the portable computer 300 may provide via the user interface 320 a list of assets to inspect. The inspector 10 physically locates an asset 20 and places the RFID transceiver 310 in close proximity to the RFID tag 100 attached to the asset 20 for communication therewith. The RFID tag 100 includes an RFID tag memory 110 shown in FIG. 4, which may include an RFID tag directory 111, a general record 112, and a historical record 113. The historical record 113 may contain a number of management records 114. The RFID tag directory 111 is an index to the data stored in both the general record 112 and the historical record 113. The general record 112 may include asset identification, asset owner identification, asset serial number, expected asset location, asset in-service date, recommended time between management inspections, and hyperlinks to further information pertaining to the asset. The general record 112 may include asset class and type, for example, a class of assets may be class=“Fire Extinguisher” or class=“Forklift” and a type of class=“Fire Extinguisher” may be type=“Powder” or “ACME456.” Assets may be grouped based on class or type. The management records 114 of the historical record 113 may include data related to previously performed inspections of the asset 20, such as observation, check, or value (OCV) results of such inspection, date and time stamps of when such inspection was performed, and identification of the inspector who performed such inspection.

The portable computer 300 may provide to the inspector 10, via the display element 321, guidance or instructions for the management inspection of the asset 20 whose RFID tag memory 110 has just been read by the RFID transceiver 310 and processed by the portable computer 300. Processing of the RFID tag memory 110 may involve the portable computer 300 accessing the portable computer database 331 with the data obtained from the general record 112. The portable computer database 331 may have stored therein the guidance or instructions, including pictures, drawings, technical drawings, schematics or graphics, relevant to the inspection of the asset 20. The inspector 10 may follow such guidance or instructions, which may include observations, checks, and values, any of which individually or collectively is heretofore referred to as an OCV. For example, an observation may be “forklift needs cleaning” a check may be “does hydraulic line contain cracks,” and a value may be “enter hydraulic line pressure.” Certain OCVs may be mandatory while others may be optional. An OCV may be determined by the class and type of the asset 20 under inspection, as well as the authorization level of the inspector 10 based on authentication performed prior to inspection. For example, only an inspector 10 with an appropriately high authorization level would be prompted by the portable computer 300 to perform the action “open maintenance bay door to nuclear reactor.”

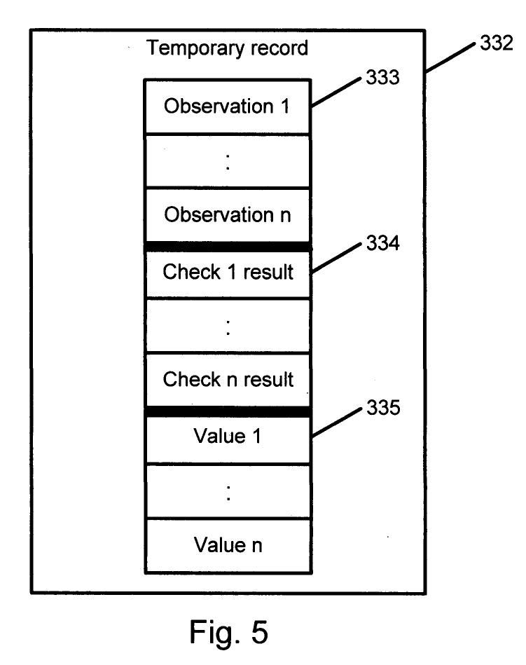

The result of each OCV is entered by the inspector 10 into the portable computer 300 via the user input element 322. The portable computer 300 stores each OCV in the temporary record 332 of the portable computer memory 330, shown in FIG. 5. The temporary record 332 may include observations results 333, check results 334, and value results 335. The software running on the portable computer 300 may perform auditing of the OCV inputs. For example, if the inspector 10 enters a value that is out of the appropriate range for a particular asset 20 based on its class and type, the inspector 10 may be prompted by the portable computer 300 to either correct such entry or commit to the value as entered.

Once the inspection of the asset 20 is complete, the inspector 10 may commit the temporary record 332 by entering into the portable computer 300 his or her desire to do so. Upon temporary record commitment, the portable computer 300 generates a management record 114 which may include the identification of the inspector, the date and time of temporary record commitment, and the temporary record 332. The portable computer 300 instructs the RFID transceiver 310 to scan for the RFID tag 100 attached to the asset 20 for which the inspection was just completed. Once the RFID transceiver 310 locates such RFID tag 100, the newly generated management record 114 is written to the historical record 113 of such, and only such, RFID tag 100.

The portable computer 300 may record into the portable computer database 331 the newly generated management record 114 during temporary record commitment. The portable computer 300 may also record into portable computer database 331 the time and date of temporary record commitment, or other relevant metadata pertaining to the inspection of the asset 10 or temporary record 332. Such metadata can be used to fix the location of the inspector 10 at the asset 20 during the time of temporary record commitment. This is especially important for mandatory OCV. At a time when a network 341 is available, or at a time of the inspector 10 or other user of the portable computer 300 so desires, the portable computer database 331 may synchronize with the central database 410, uploading thereto the newly generated management record 114, any metadata, or any other relevant data and downloading therefrom any relevant or important data. The central database 410 may store the data required to initialize RFID tags 100 and RFID badges 200. Data relevant to the general record 112 of an asset 20, which may be required upon RFID tag 100 initialization or update, may be entered into the central database 410 or imported into the central database 410 from another system.

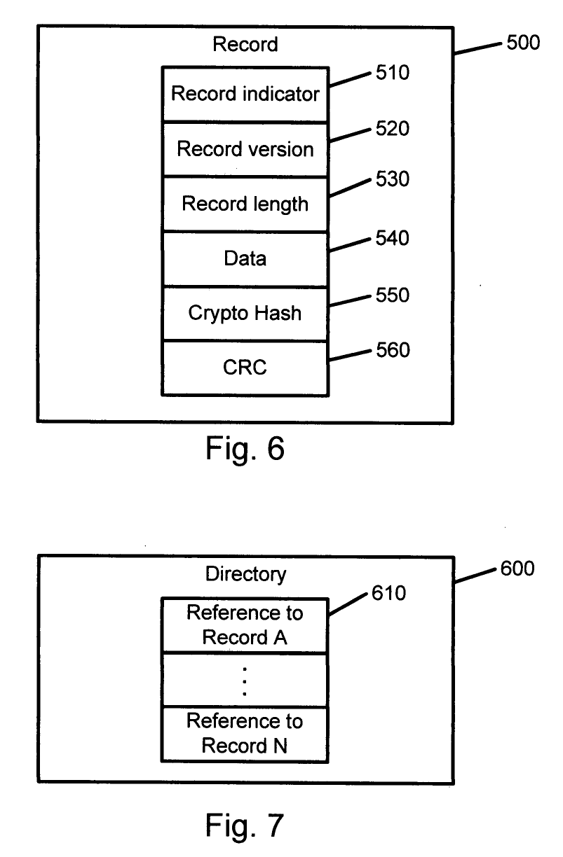

The general structure of a record 500, including a management record 114, a general record 112, and an authentication record 212, is shown in FIG. 6. Such record 500 may include the record type 510, record version 520, record length 530, record data 540, a cryptographic hash 550, and a CRC 560. Examples of record types 510 are “Maintenance,” “General” and “Authentication.” The record version 520 permits the use and compatibility of various versions of records 500. The record length 530 is the length of the record 500 in bits, bytes, words, entries, or any other convenient measurement. The record data 540 is the actual data pertaining to the record 500, for example a temporary record 332. The cryptographic hash 550 is data pertaining to any convenient encryption or decryption algorithm necessary to encrypt or decrypt the record 500 for security and authenticity of the data therein. Such security helps ensure authenticity of the historical record 113. If the historic record 113 has somehow been maliciously altered or faked, this will be detected by the cryptographic hash 550 when read by an RFID transceiver 310 and processed by the portable computer 300. The RFID tag UID 120 is included in the hash encryption calculation to prevent malicious swapping of entire RFID tags 100 by copying of information from one RFID tag 100 to another RFID tag 100. The hash encryption can be any secure cryptographic hash function, such as the Message-Digest algorithm (MD5), SHA-1 or SHA-256. Other means to ensure authenticity of the historic record 113 may be used instead of or in addition to the cryptographic hash 550, for example parts of the RFID tag memory 110 can be locked during writing, a feature of the Texas Instruments' HiTag product, or supplying of a key to the RFID tag 100 by the portable computer 300 may be required prior to accessing the RFID tag memory 110, a feature of NXP's MiFare product. The CRC 560 is the data pertaining to any convenient Error Detecting Code (EDC), Error Correcting Code (ECC), or Forward Error Correcting Code (FEC), such as a Cyclic Redundancy Check (CRC) or parity check, of the record 500 to detect and/or correct transmission, reading, or writing errors of data between any of the communicating elements of FIG. 2. The term CRC 560 heretofore refers to any of the aforementioned codes or checks.

The general structure of a directory 600, including an RFID badge directory 211 and an RFID tag directory 111, is shown in FIG. 7. Such directory 600 may include references to records, such as a reference to general record 610, references to management records 114 or a reference to authentication record 212. For example, an RFID badge directory 211 may include a reference to an authentication record 212. Similarly, an RFID tag directory 111 may include a reference to a general record 112 and references to multiple management records 114. Such a directory 600 reduces the time to read RFID tags 100 and RFID badges 200 by permitting direct access to each record 500 rather than a linear search through multiple records 500 to locate the record 500 of interest.

FIG. 9 summarizes the basic asset management steps 800, starting with the start step 805 and ending with the end step 890. First, the inspector 10 authenticates as shown in step 700 (see FIG. 8 for details of this step). In step 810, the inspector 10 reads the RFID tag 100 of an asset 20 using a portable computer 300 with an RFID transceiver 310. In step 820, the portable computer 300 processes such data. Next, in step 830, the portable computer 300 displays the general information of the asset 20 retrieved from its RFID tag 100 as well as specific tasks pertaining to the inspection or management of the asset, determined during the processing step 820. The inspector 10 may be guided through the inspection by the portable computer 300 and the inspector 10 may enter the results of such inspection in step 840. The portable computer 300 may audit the entered results in step 850. On completion of step 850, in step 860 the portable computer 300 may generate a management record with the results of the inspection, which may include cryptographic functions. Finally, in step 870, the portable computer 300 may write the management record to the RFID tag 100. If there are no more assets 20 to be inspected, asset management is complete. The results of the asset management may be synchronized with a central database 410 at any time during of after the asset management, using a wired or wireless data connection 341. Such synchronization and the network connection therefore may be protected by any suitable encryption or security means.

What is claimed is:

1. A asset management system comprising:
an RFID tag attached to an asset, said RFID tag comprising
a unique identifier and
an RFID tag memory that can be read from and written to, said RFID tag memory comprising
a general record that includes a cryptographic hash field and
a historical record that may include at least one management record, said management record including a cryptographic hash field;
an RFID badge carried by an inspector of said asset, said RFID badge comprising
a unique identifier and
an RFID badge memory that can be read from and written to, said RFID badge memory comprising an authentication record of said inspector, said authentication record including a cryptographic hash field;
an RFID transceiver that may wirelessly communicate with
said RFID tag and
said RFID badge;
a portable computer that cooperates with said RFID transceiver, said portable computer comprising
a user interface comprising
a display element,
an input element, and
a network interface,
a portable computer memory comprising
a local database and
a temporary record of the management of said asset; and
a database server comprising
a central database and
a network interface.

2. A method of using said asset management system of claim 1 comprising:
said inspector placing said RFID badge in close proximity to said RFID transceiver;
said portable computer cooperating with said RFID transceiver to read said RFID memory of said RFID badge;
said portable computer prompting said inspector to enter a passcode via said display element;
said portable computer calculating a cryptographic hash over said entered passcode;
said portable computer comparing said cryptographic hash calculated over said entered passcode with the contents of said cryptographic hash field stored in said authentication record of said RFID badge memory;
wherein said inspector is authenticated only if said cryptographic hash calculated over said entered passcode matches said contents of said cryptographic hash field stored in said authentication record of said RFID badge memory.

3. The method of claim 2 further comprising:
said RFID transceiver cooperating with said portable computer to read said RFID tag memory of said RFID tag attached to said asset;
said portable computer processing contents of said RFID tag memory;
said portable computer displaying results of said processing of contents of said RFID tag memory via said display element;
said portable computer prompting said inspector to perform tasks for said management of said asset;
said inspector entering results of said management of said asset into said portable computer via said input element;
said portable computer storing said entered results of said management of said asset in said temporary record;
said portable computer auditing said temporary record;
said portable computer generating a management record;
said portable computer cooperating with said RFID transceiver to write said generated management record to said RFID tag memory attached to said asset; and
said portable computer writing said generated management record to said local database.

4. The method of claim 3 wherein said data field of said generated management record includes an identifier of said inspector and a timestamp establishing the time at which said generated management record was generated.

5. The method of claim 4 wherein said portable computer calculates a cryptographic hash over said unique identifier of said RFID tag and said record indicator, said record version, said record length, and said data field of said generated management record, said portable computer including said calculated cryptographic hash in said cryptographic hash field of said generated management record written to said RFID tag memory attached to said asset.

6. The method of claim 5 wherein said portable computer calculates a cyclic redundancy check over said record indicator, said record version, said record length, said data field, and said cryptographic hash field of said generated management record, said portable computer including said calculated cyclic redundancy check in said cyclic redundancy check field of said generated management record written to said RFID tag memory attached to said asset.

7. The method of claim 6 further comprising:
said portable computer writing said generated management record to said central database of said database server via a network connected to said network interface of said portable computer and said network interface of said database server.

8. A asset management system comprising:
an RFID tag attached to an asset, said RFID tag comprising
a unique identifier and
an RFID tag memory that can be read from and written to, said RFID tag memory comprising
a general record that includes
a record indicator,
a record version,
a record length,
a data field,
a cryptographic hash field, and
a cyclic redundancy check field, and
a historical record that may include at least one management record, said management record including
a record indicator,
a record version,
a record length,
a data field,
a cryptographic hash field, and
a cyclic redundancy check field;
an RFID badge carried by an inspector of said asset, said RFID badge comprising
a unique identifier and
an RFID badge memory that can be read from and written to, said RFID badge memory comprising an authentication record of said inspector, said authentication record including
a record indicator,
a record version,
a record length,
a data field,
a cryptographic hash field, and
a cyclic redundancy check field;
an RFID transceiver that may wirelessly communicate with
said RFID tag and
said RFID badge;
a portable computer that cooperates with said RFID transceiver, said portable computer comprising
a user interface comprising
a display element,
an input element, and
a network interface,
a portable computer memory comprising
a local database and
a temporary record of the management of said asset; and
a database server comprising
a central database and
a network interface.

9. A method of using said asset management system of claim 8 comprising:
said inspector placing said RFID badge in close proximity to said RFID transceiver;
said portable computer cooperating with said RFID transceiver to read said RFID memory of said RFID badge;
said portable computer prompting said inspector to enter a passcode via said display element;
said portable computer calculating a cryptographic hash over said entered passcode;
said portable computer comparing said cryptographic hash calculated over said entered passcode with the contents of said cryptographic hash field stored in said authentication record of said RFID badge memory;
wherein said inspector is authenticated only if said cryptographic hash calculated over said entered passcode matches said contents of said cryptographic hash field stored in said authentication record of said RFID badge memory.

10. The method of claim 9 further comprising:
said RFID transceiver cooperating with said portable computer to read said RFID tag memory of said RFID tag attached to said asset;
said portable computer processing contents of said RFID tag memory;
said portable computer displaying results of said processing of contents of said RFID tag memory via said display element;
said portable computer prompting said inspector to perform tasks for said management of said asset;
said inspector entering results of said management of said asset into said portable computer via said input element;
said portable computer storing said entered results of said management of said asset in said temporary record;
said portable computer auditing said temporary record;
said portable computer generating a management record;
said portable computer cooperating with said RFID transceiver to write said generated management record to said RFID tag memory attached to said asset; and
said portable computer writing said generated management record to said local database.

11. The method of claim 10 wherein said data field of said generated management record includes an identifier of said inspector and a timestamp establishing the time at which said generated management record was generated.

12. The method of claim 11 wherein said portable computer calculates a cryptographic hash over said unique identifier of said RFID tag and said record indicator, said record version, said record length, and said data field of said generated management record, said portable computer including said calculated cryptographic hash in said cryptographic hash field of said generated management record written to said RFID tag memory attached to said asset.

13. The method of claim 12 wherein said portable computer calculates a cyclic redundancy check over said record indicator, said record version, said record length, said data field, and said cryptographic hash field of said generated management record, said portable computer including said calculated cyclic redundancy check in said cyclic redundancy check field of said generated management record written to said RFID tag memory attached to said asset.

14. The method of claim 13 further comprising:
said portable computer writing said generated management record to said central database of said database server via a network connected to said network interface of said portable computer and said network interface of said database server.

15. A asset management system comprising:
an RFID tag attached to an asset, said RFID tag comprising
a unique identifier and
an RFID tag memory that can be read from and written to, said RFID tag memory comprising
a general record that includes
a record indicator,
a record version,
a record length,
a data field,
a cryptographic hash field, and
a cyclic redundancy check field, and
a historical record that may include at least one management record, said management record including
a record indicator,
a record version,
a record length,
a data field,
a cryptographic hash field, and
a cyclic redundancy check field, and
a directory for indexing said general record, said historical record, and said management record;
an RFID badge carried by an inspector of said asset, said RFID badge comprising
a unique identifier and
an RFID badge memory that can be read from and written to, said RFID badge memory comprising
an authentication record of said inspector, said authentication record including
a record indicator,
a record version,
a record length,
a data field,
a cryptographic hash field, and
a cyclic redundancy check field, and
a directory for indexing said authentication record;
an RFID transceiver that may wirelessly communicate with
said RFID tag and
said RFID badge;
a portable computer that cooperates with said RFID transceiver, said portable computer comprising
a user interface comprising
a display element,
an input element, and
a network interface,
a portable computer memory comprising
a local database and
a temporary record of the management of said asset; and
a database server comprising
a central database and
a network interface.

16. A method of using said asset management system of claim 15 comprising:
said inspector placing said RFID badge in close proximity to said RFID transceiver;
said portable computer cooperating with said RFID transceiver to read said RFID memory of said RFID badge;
said portable computer prompting said inspector to enter a passcode via said display element;
said portable computer calculating a cryptographic hash over said entered passcode;
said portable computer comparing said cryptographic hash calculated over said entered passcode with the contents of said cryptographic hash field stored in said authentication record of said RFID badge memory;
wherein said inspector is authenticated only if said cryptographic hash calculated over said entered passcode matches said contents of said cryptographic hash field stored in said authentication record of said RFID badge memory.

17. The method of claim 16 further comprising:
said RFID transceiver cooperating with said portable computer to read said RFID tag memory of said RFID tag attached to said asset;
said portable computer processing contents of said RFID tag memory;
said portable computer displaying results of said processing of contents of said RFID tag memory via said display element;
said portable computer prompting said inspector to perform tasks for said management of said asset;
said inspector entering results of said management of said asset into said portable computer via said input element;
said portable computer storing said entered results of said management of said asset in said temporary record;
said portable computer auditing said temporary record;
said portable computer generating a management record;
said portable computer cooperating with said RFID transceiver to write said generated management record to said RFID tag memory attached to said asset; and
said portable computer writing said generated management record to said local database.

18. The method of claim 17 wherein said data field of said generated management record includes an identifier of said inspector and a timestamp establishing the time at which said generated management record was generated.

19. The method of claim 18 wherein said portable computer calculates a cryptographic hash over said unique identifier of said RFID tag and said record indicator, said record version, said record length, and said data field of said generated management record, said portable computer including said calculated cryptographic hash in said cryptographic hash field of said generated management record written to said RFID tag memory attached to said asset.

20. The method of claim 19 wherein said portable computer calculates a cyclic redundancy check over said record indicator, said record version, said record length, said data field, and said cryptographic hash field of said generated management record, said portable computer including said calculated cyclic redundancy check in said cyclic redundancy check field of said generated management record written to said RFID tag memory attached to said asset.

21. The method of claim 20 further comprising:
said portable computer writing said generated management record to said central database of said database server via a network connected to said network interface of said portable computer and said network interface of said database server.
